(19) United States
(12) Patent Application Publication
(10) Pub. No.: US 2022/0190615 A1
(43) Pub. Date: Jun. 16, 2022

(54) APPARATUS, SYSTEM, AND METHOD FOR PROVIDING POWER

(71) Applicant: MICROGREEN SOLAR INC., RICHMOND HILL (CA)

(72) Inventors: PETER WETZEL, INNISFIL (CA); DAVY HUNG, TORONTO (CA); RONGKAI HONG, TORONTO (CA)

(73) Assignee: MICROGREEN SOLAR INC., RICHMOND HILL, ON (CA)

(21) Appl. No.: 17/437,992

(22) PCT Filed: Mar. 18, 2020
(86) PCT No.: PCT/CA2020/050356

§ 371 Date: Sep. 10, 2021

Related U.S. Application Data
(60) Provisional application No. 62/820,553, filed on Mar. 19, 2019.

(51) Int. Cl. H02J 7/00; H02J 3/32

(52) U.S. Cl. CPC H02J 7/0063; H02J 2300/40; H02J 3/32; H02J 7/007182

(57) ABSTRACT

Apparatus for providing power includes a charge controller, an inverter, a power storage subsystem, and a relay control subsystem. The apparatus further includes a first, second, and third input coupling a first power source, a second power source, and the power storage subsystem, respectively, to the inverter. The apparatus further includes a first output coupling the power storage subsystem to the charge controller and inverter, and a second output coupling a load to the inverter. The first power source provides DC power, the second power source provides AC power, and the power storage subsystem provides DC power. The apparatus further includes a housing, which supports the charge controller, inverter, power storage subsystem, relay control subsystem, inputs, and outputs. The relay control subsystem may be coupled to a user device, allowing remote control of the relay control subsystem. A user may control transmission of power to outlets with the user device.

### CROSS REFERENCES TO RELATED APPLICATIONS:

This application claims the benefit of and/or priority from U.S. Provisional Patent Application No. 62/820,553 filed on Mar. 19, 2019, which is incorporated herein by reference in its entirety.

### FIELD

This document relates to power supply. More specifically, this document relates to apparatuses, systems, and methods for providing power to loads.

### SUMMARY

The following summary is intended to introduce the reader to various aspects of the detailed description, but not to define or delimit any invention.

Apparatuses for providing power are disclosed. According to some aspects, an apparatus for providing power includes a charge controller coupled to an inverter, a relay control subsystem coupled to the inverter, and a first input for coupling a first power source to the charge controller. The charge controller can receive a first amount of power from the first power source via the first input, and adapt the received first amount of power for storage in a power storage subsystem. The apparatus further includes a second input for coupling a second power source to the inverter. The inverter can receive a second amount of power from the second power source via the second input, and adapt the received second amount of power for storage in the power storage subsystem. The apparatus further includes a third input for coupling the power storage subsystem to the inverter. The inverter can receive a third amount of power from the power storage subsystem, and convert the received third amount of power into alternating current (AC) power. The apparatus further includes a first output for coupling the power storage subsystem to the charge controller and inverter. The charge controller can charge the power storage subsystem with the adapted received first amount of power, and/or the inverter can charge the power storage subsystem with the adapted second amount of power. The apparatus further includes a second output coupled to the inverter. The inverter can transmit the AC power to the second output. The apparatus further includes a housing, which supports the charge controller, inverter, relay control subsystem, first input, second input, third input, first output, and second output.

Methods for providing power are also disclosed. According to some aspects, a method for providing power includes: providing a charge controller coupled to an inverter; providing a relay control subsystem coupled to the inverter; providing a first input for coupling a first power source to the charge controller and enable the charge controller to receive a first amount of power from the first power source via the first input, and adapt the received first amount of power for storage in a power storage subsystem; providing a second input for coupling a second power source to the inverter and thereby enable the inverter to receive a second amount of power from the second power source via the second input, and adapt the received second amount of power for storage in the power storage subsystem; providing a third input for coupling the power storage subsystem to the inverter and thereby enable the inverter to receive a third amount of power from the power storage subsystem, and convert the received third amount of power into alternating current (AC) power; providing a first output for coupling the power storage subsystem to the charge controller and inverter, thereby enabling at the charge controller to charge the power storage subsystem with the adapted received first amount of power, and/or the inverter to charge the power storage subsystem with the adapted received second amount of power; providing a second output coupled to the inverter, wherein the inverter transmits the AC power to the second output; and providing a housing supporting the charge controller, inverter, relay control subsystem, first input, second input, third input, first output, and second output.

Systems for providing power are also disclosed. According to some aspects, a system for providing power includes a first power source, a second power source, a power storage sub-system, and an apparatus for providing power to a load from at least one of the first power source, the second power source, and the power storage sub-system. The apparatus includes a charge controller coupled to an inverter, a relay control subsystem coupled to the inverter, and a first input for coupling the first power source to the charge controller. The charge controller can receive a first amount of power from the first power source via the first input, and adapt the received first amount of power for storage in the power storage subsystem. The apparatus further includes a second input for coupling the second power source to the inverter. The inverter can receive a second amount of power from the second power source via the second input, and adapt the received second amount of power for storage in the power storage subsystem. The apparatus further includes a third input for coupling the power storage subsystem to the inverter. The inverter can receive a third amount of power from the power storage subsystem, and convert the received third amount of power into alternating current (AC) power. The apparatus further includes a first output for coupling the power storage subsystem to the charge controller and inverter. The charge controller can charge the power storage subsystem with the adapted received first amount of power, and the inverter can charge the power storage subsystem with the adapted second amount of power. The apparatus further includes a second output coupled to the inverter. The inverter can transmit the AC power to the second output for providing power to a load. A housing supports the charge controller, inverter, relay control subsystem, first input, second input, third input, first output, and second output.

### BRIEF DESCRIPTION OF THE DRAWINGS

The drawings included herewith are for illustrating various examples of articles, methods, and apparatuses of the present specification and are not intended to limit the scope of what is taught in any way. In the drawings:

FIG. 1 is a block diagram of an example system for providing power;

FIG. 2 is a block diagram of the inverter of FIG. 1A;

FIG. 3 is a block diagram of a power management system including the system of FIG. 1

FIG. 4 is a block diagram of an example user device;

FIG. 5 is a block diagram of an example power analysis subsystem;

FIG. 6 is a perspective view of the apparatus for providing power of FIG. 1;

FIG. 7 is a top view of the apparatus of FIG. 6;

FIG. 8 is a left side view of the apparatus of FIG. 6; and

FIG. 9 is a front view of the apparatus of FIG. 6.

### DETAILED DESCRIPTION

Various apparatuses or processes or compositions will be described below to provide an example of an embodiment of the claimed subject matter. No embodiment described below limits any claim and any claim may cover processes or apparatuses or compositions that differ from those described below. The claims are not limited to apparatuses or processes or compositions having all of the features of any one apparatus or process or composition described below or to features common to multiple or all of the apparatuses or processes or compositions described below. It is possible that an apparatus or process or composition described below is not an embodiment of any exclusive right granted by issuance of this patent application. Any subject matter described below and for which an exclusive right is not granted by issuance of this patent application may be the subject matter of another protective instrument, for example, a continuing patent application, and the applicants, inventors or owners do not intend to abandon, disclaim or dedicate to the public any such subject matter by its disclosure in this document.

Generally disclosed herein is an apparatus for providing power, and related systems and methods. The apparatus can provide a turnkey solution for storage of power from multiple sources (e.g. a solar panel, a fuel-powered generator, a wind turbine, and/or an electrical grid) and/or provision of power from multiple sources to a load (e.g. a house, or a building, or a cottage, or an RV or other vehicle, or a boat, or machinery). The apparatus can be readily installed (e.g. by the consumer), and can enable connection of power sources, power storage systems, and loads in a simple, easy-to-install manner. Furthermore, the apparatus can be pre-inspected and certified, which can obviate the need for additional inspection and can therefore reduce costs.

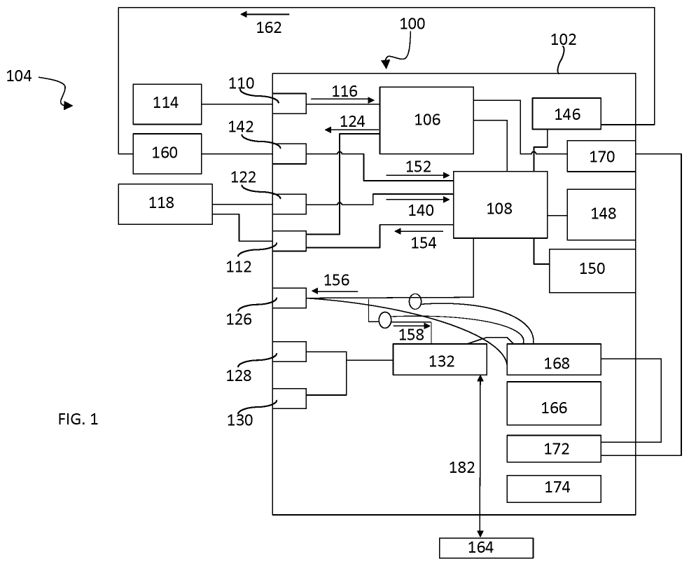

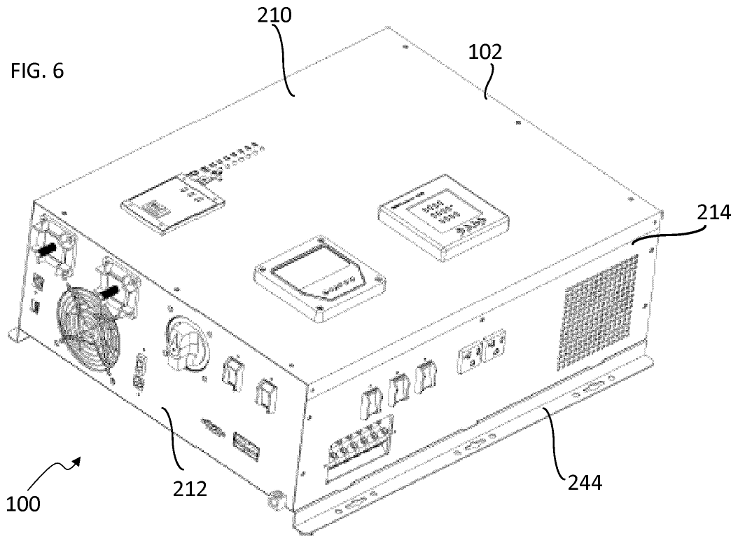

FIGS. 1 to 5 show block diagrams of various features of an example apparatus 100 for providing power, and related systems. FIGS. 6 to 9 show the apparatus 100 itself. As can be seen most clearly in FIGS. 6 to 9, the apparatus 100 includes a housing 102, which is relatively compact. The housing 102 encloses certain parts of apparatus 100 and supports other parts of apparatus 100 on faces thereof, for access by a user. Providing the components of apparatus 100 in or on a unitary housing can allow for ready installation and connection.

Referring now to FIG. 1, an example system 104 is shown, which includes apparatus 100. In the example shown, the apparatus 100 includes a charge controller 106, an inverter 108, an input 110 (also referred to as a ‘first input’), and an output 112 (also referred to as a ‘first output’). The charge controller 106 is coupled to the inverter 108, the input 110, and the output 112. The input 110 can connect an external power source 114 to the charge controller 106, thereby enabling the charge controller 106 to receive power 116 (also referred to herein as ‘a first amount of power’) from the power source 114 via input 110. The power source 114 can be, for example, a DC source. In some examples, the DC source is a renewable energy power source such as one or more solar cells or wind turbines. In yet other examples, the power source 114 is a gas generator. In some examples, the input 110 includes protection such as breakers (described in further detail below) to protect the charge controller 106.

Referring still to FIG. 1, in the example shown, the charge controller 106 manages the supply of power to charge an external power storage subsystem 118. The charge controller 106 adapts received power 116 to facilitate or optimize power delivery to charge the power storage subsystem 118. The charge controller 106 can be, for example, a maximum power point tracking (MPPT) controller or a pulse width modulation (PWM) controller. The operation of MPPT and PWM charge controllers is not described in detail herein. The adaptation performed by charge controller 106 can include, for example, stepping down the voltage received from the power source 114 so as not to damage the power storage subsystem 118. The power storage subsystem 118 is coupled to charge controller 106 via output 112 (and also via input 122, described below). The charge controller 106 supplies power 124 (also referred to herein as ‘a second amount of power’) to output 112 for storage in the power storage subsystem 118. Power 124 is adapted from received power 116. In some examples, output 112 includes protection such as breakers or fuses (described in more detail below) to isolate and protect the power storage subsystem 118.

The power storage subsystem 118 can be, for example, one or more batteries such as Absorbent Glass Mat (AGM) batteries, flooded acid batteries, gel type batteries or lithium batteries. In some examples (as described in more detail below), the apparatus 100 includes a power storage subsystem selector switch to select a type of battery, or stop the charging of the power storage subsystem 118 from the inverter 108. The apparatus 100 can further include a power storage subsystem switch (as described in more detail below), to disconnect (i.e. isolate) the power storage subsystem 118 from apparatus 100.

Referring still to FIG. 1, the inverter 108 is coupled to charge controller 106, inputs 110 and 122 (also referred as a ‘third input’), output 112, output 126 (also referred to as a ‘second output’), and outputs 128 and 130 (also referred to herein as a ‘third output’ and a ‘fourth output’, described in further detail below) via a relay control subsystem 132.

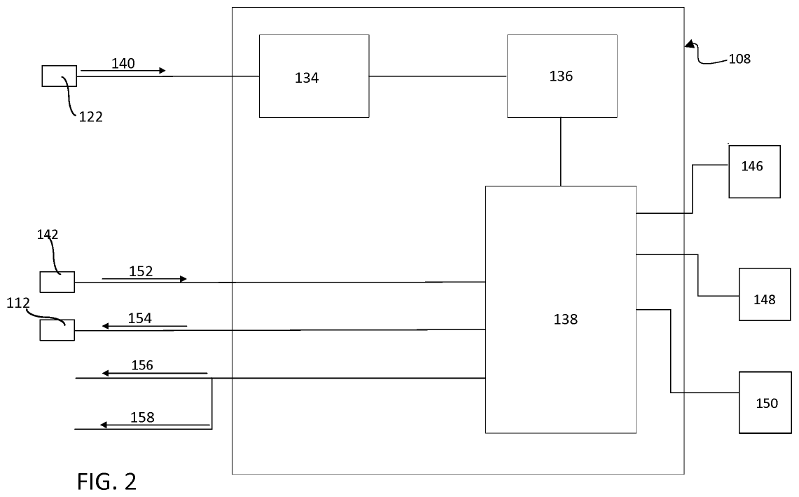

Referring to FIG. 2, the inverter 108 includes power board 134, a transformer 136, and a control board 138. The power board 134 is coupled to transformer 136 and receives power 140 from input 122. Control board 138 is coupled to transformer 136, inputs 122 and 142, output 112, and an automatic generator start (AGS) 146 (described in further detail below), inverter switches 148 (described in further detail below), and remote switch ports 150 (described in further detail below). Control board 138 receives power 152 from input 142, receives power 140 via power board 134 and transformer 136, and transmits power 154 to output 112, and transmits AC power 156 and AC power 158.

Referring back to FIG. 1, the input 142 (also referred to herein as a ‘second input’) couples an external power source 160 to the inverter 108, thereby enabling the inverter to receive power 152 via the input 142. The power source 160 can be, for example, an AC source such as a generator or an electrical grid. The inverter 108 adapts the received power 152 to produce power 154 for storage in the power storage subsystem 118. The output 112 couples the power storage subsystem 118 to the inverter 108. Power 154 is supplied to the power storage subsystem 118 via the output 112. Therefore, power 124 and or power 154 is stored in the power storage subsystem 118 via the output 112.

Referring still to FIG. 1, in the example shown, the inverter 108 is controlled by inverter switches 148. The inverter switches 148 can be used to control one or more settings for the inverter 108. These settings include, for example: frequency of operation; battery levels for power source 160; choosing between uninterrupted power supply (UPS) and off-grid modes; AC input voltage range; and power saver settings. The inverter switches 148 can be implemented using, for example, dual in-line package (DIP) switches.

Referring still to FIG. 1, in the example shown, the inverter 108 has two modes of operation: charging mode and inverting mode. In charging mode, the inverter 108 monitors a voltage and current corresponding to power 152. The input 122 couples power storage subsystem 118 to the inverter 108, thereby enabling the inverter 108 to receive power 140 from the power storage subsystem 118 via the input 122. When the inverter 108 detects that power 152 has fallen below a threshold, the inverter 108 goes into inverting mode. In inverting mode, the inverter 108 converts received power 140 into AC power, which is transmitted as AC power 156 (also referred to herein as ‘a first amount of AC power’) and AC power 158 (also referred to herein as ‘a second amount of AC power). AC power 156 is sent to the output 126 to, for example, supply power to a load such as a house, a recreational vehicle (RV), power tools, kitchen equipment, or any other facility or equipment as necessary. In some examples, the load is a split-phase load.

Referring still to FIG. 1, in the example shown, the apparatus 100 includes an AGS unit 146 (mentioned above), which can send a signal 162 to turn on or turn off the power source 160. Furthermore, the inverter 108 can detect a voltage level associated with the power storage subsystem 118. When the voltage level drops below a threshold level, the inverter 108 can use the AGS unit 146 to send the signal 162 to enable the power source 160 to supply power to charge up the power storage subsystem 118. For example, where the power source 160 is an AC generator, the inverter 108 can use the AGS unit 146 to send a signal 162 to start the generator. For further example, when the power storage subsystem 118 is charged up, the inverter 108 can use the AGS unit 146 to send signal 162 to switch off power source 160.

Referring still to FIG. 1, AC power 158 is sent to the relay control subsystem 132, which is coupled to outputs 128 and 130. The output 128 and/or the output 130 can be a receptacle or power outlet to enable plug-in of a device so that it can be powered by AC power 158. The relay control subsystem 132 can control the transmission of AC power 158 to outputs 128 and 130. In the example shown, this control is done with a user device 164 (described in further detail below).

Referring still to FIG. 1, in the example shown, the apparatus 100 includes a temperature control subsystem 166. The temperature control subsystem 166 can include, for example, one or more fans, coolers, heat sinks, temperature sensors, exhaust vents or other components for measuring and/or controlling temperature to facilitate safe, reliable and optimal operation of apparatus100 within housing 102. In the example shown, the temperature control subsystem 166 includes two fans (described in further detail below) to provide temperature control within housing 102. One of the fans can be an AC fan which begins working once the inverter 108 goes into inverting mode. One of the fans can be a DC fan. The speed of the DC fan can vary depending on parameters such as temperatures, currents and percentage of maximum load. This variable speed feature can facilitate high reliability and safety.

As mentioned above, the temperature control subsystem 166 can include one or more temperature sensors. In some examples, the temperature sensors are associated with charge controller 106 and inverter 108 respectively. In some examples, these temperature sensors are used to detect the temperature of the power storage subsystem 118, and adapt at least one of power 124 and power 154 for storage in power storage subsystem 118.

Referring still to FIG. 1, in the example shown, the apparatus 100 includes an AC meter 168 to measure, for example, AC power 156 and 158. The AC meter 168 can allow a user to measure levels of output AC voltage and AC current using associated current and voltage sensors. These measured levels can then be displayed to a user. The AC meter 168 can also enable display of the total power used since the last time the reading was reset.

Referring still to FIG. 1, in the example shown, the apparatus 100 further includes a DC meter 170 coupled to the charge controller 106. The DC meter 170 can measure, for example, the state of charge from the power source 114 to the power storage subsystem 118, and/or the present state of the storage level in power storage subsystem 118.

Referring still to FIG. 1, in the example shown, the apparatus includes displays 172 to enable users to view, for example, the status of apparatus 100 and/or system 104, and the levels of different parameters within the apparatus 100 and/or system 104. Such parameters can include, for example, measurements from the DC meter 170, and measurements from the AC meter 168. The displays 172 can also include indicators to indicate different conditions, for example: whether the inverter 108 is on, whether the apparatus 100 is in power saver mode, the stage of charging, whether the inverter 108 is overloaded, whether the inverter 108 is in an over temperature state, and whether there is a fault. The displays 172 are described in further detail below with reference to FIGS. 6 to 9.

Referring still to FIG. 1, in the example shown, the apparatus 100 further includes alarms 174 for indicating different conditions or a need for user intervention. These could be, for example, temperature overloads and low or high battery voltages.

Referring still to FIG. 1, as mentioned above, in the example shown the apparatus 100 further includes remote switch ports 150. Remote switch ports 150 can include one or more connection points for a user to plug in a remote switch. This can allow the user to turn apparatus 100 on or off from a distance.

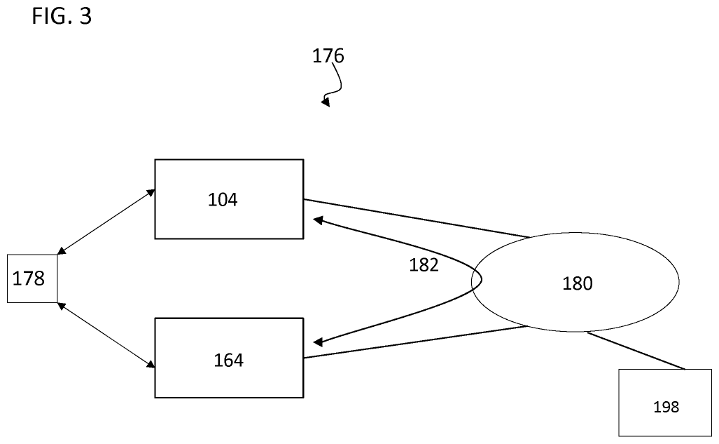

Referring now to FIG. 3, apparatus 100 and system 104 can be part of a larger power management system 176. System 176 can enable a user such as user 178 to remotely view, monitor, provide feedback and control apparatus 100 and system 102. In system 176, interconnections 180 perform the function of communicatively coupling the various components of system 176 to each other. Interconnections 180 may be implemented in a variety of ways. For example, interconnections 180 can include one or more networks, which can include one or more subnetworks. The networks can include, for example, wireless networks, wired networks, Ethernet networks, local area networks, metropolitan area networks and optical networks. The networks can include a private network such as a virtual private network, or a public network such as the Internet. Interconnections 180 can also include one or more direct connections between the components of system 176. Various wired or wireless communications protocols may be used to implement interconnections 180. These include, for example, near field communications (NFC), Wi-Fi, BLUETOOTH®, Radio Frequency Identification (RFID), 3G, Long Term Evolution (LTE), 5G, LORA and Universal Serial Bus (USB). As shown in FIGS. 1 and 3, the user device 164 can send information 182 via interconnections 180 to monitor and control relay control subsystem 132.

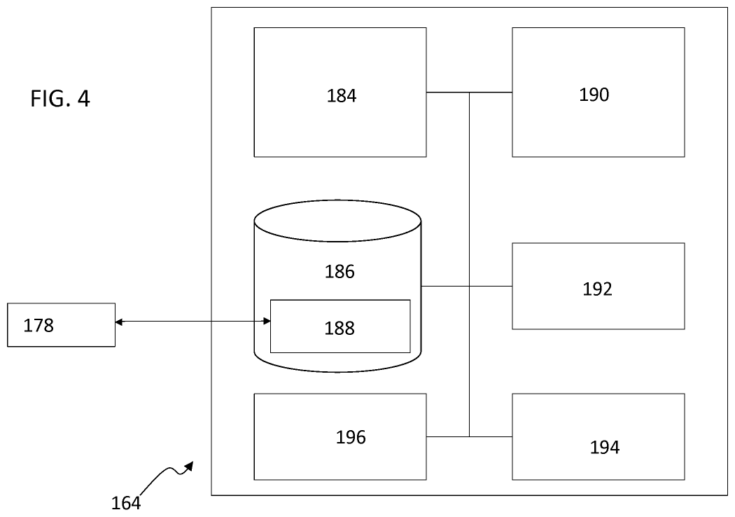

Referring to FIG. 4, in the example shown, the user device 164 is associated with user 178. User device 164 can be, for example a smartwatch, smartphone, tablet, laptop, or another computing and network-enabled device. In the example shown, user device 164 includes a processor 184, which performs processing functions and operations necessary for the operation of user device 164, using data and programs stored in storage 186. An example of such a program is application or “app” 188 which will be discussed in more detail below. App 188 allows user 178 to interact with apparatus 100, system 104, and system 176 via user device 164. The user device 164 further includes a display 190, which performs the function of displaying data and information for user 178. The user device 164 further includes input device 192, which allow user 178 to enter information. Input device 192 can be, for example, a touch screen, mouse, keypad, keyboard, microphone, camera, and/or video camera. Optionally, display 190 and input device 192 can be combined in a touchscreen.

Referring still to FIG. 4, the user device 164 further includes a communications module 194, which allows user device 164 to communicate with devices and networks external to user device 164. For example, user device 164 can communicate with the other components of apparatus 100 via interconnections 180 and communications module 194. Communications module 194 can support one or more wired or wireless communications via protocols and technologies such as BLUETOOTH®, Wi-Fi, Near Field Communications (NFC), Radio Frequency Identification (RFID), 3G, Long Term Evolution (LTE), 5G, LORA and Universal Serial Bus (USB) and other protocols and technologies.

Referring still to FIG. 4, in the example shown, the user device 164 further includes sensors 196, which can sense or detect environmental or locational parameters. Sensors 196 can include, for example, accelerometers, gyroscopes, magnetometers, barometers, Global Positioning System (GPS), proximity sensors and ambient light sensors.

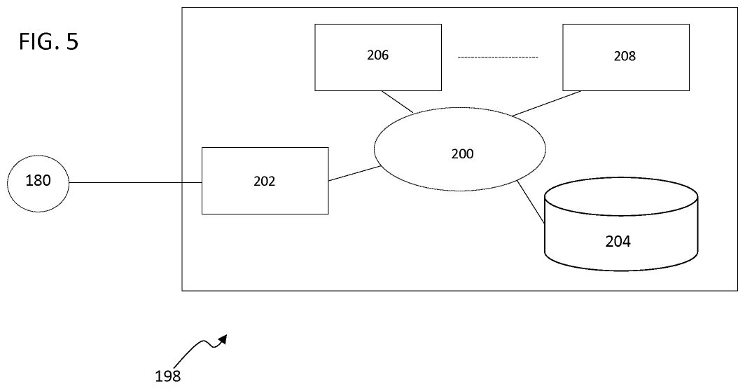

Referring now to FIG. 5, in the example shown, apparatus 100 can be in communication with a power analysis subsystem 198, which can store, analyse and monitor data relating to system 104 and apparatus 100. The power analysis subsystem 198 includes interconnection 200, which connects the various components of power analysis subsystem 198 to each other. Interconnection 200 can be implemented using, for example, network technologies such as wireless networks, wired networks, Ethernet networks, local area networks, metropolitan area networks and optical networks. Interconnection 200 can include one or more subnetworks. Interconnection 200 can include other technologies to connect multiple components to each other including, for example, buses, coaxial cables, and/or USB connections.

Referring still to FIG. 5, in the example shown, the power analysis subsystem 198 includes a communications subsystem 202, which receives information from and transmits information to the other components of system 176 via interconnections 180. The power analysis subsystem 198 further includes a database 204, which stores information and data for use by power analysis subsystem 198. This information can include, for example measurement data received from system 104 and/or apparatus 100; power consumption data calculated based on the received measurement data; storage of authentication data such as usernames and passwords to enable users to log in via app 188; and/or data related to power consumption. This data can include, for example cost per kilowatt-hour (kWh) and total costs over one or more periods of time, and/or carbon taxes per unit of emissions.

Users such as user 178 can input data to database 204 using, for example, app 188 running on user device 164. Alternatively, data can be uploaded to database 204 from other components of system 176 such as apparatus 100.

In some examples, database 204 can further include a database server. The database server can receive one or more commands from, for example, processing subsystems 206 and 208 and communication subsystem 202, and can translate these commands into appropriate database language commands to retrieve and store data into database 204. Database 204 can be implemented using one or more database languages known to those of skill in the art, including, for example, Structured Query Language (SQL). Database 204 can store data for a plurality of users. In some examples, there may be a desire to keep the data from a given user separate from the data relating to other users. To achieve this, database 204 can be partitioned so that data related to each user is separate from the other users. Each user can have an account with a login and a password or other appropriate security measures to ensure that they are able to access only their data, and unauthorized access of their data is prohibited. Optionally, when data is entered into database 204, associated metadata is added so as to make it more easily searchable. The metadata can include one or more tags. The database 204 can present an interface to enable the entering of search queries. The data stored within database 204 can be encrypted for security reasons.

Referring still to FIG. 5, processing subsystems 206 and 208 can perform processing and analysis within power analysis subsystem 198, using one or more algorithms and programs residing on power analysis subsystem 198, data received from communications subsystem 202, and one or more portions of calculation data and/or other data retrieved from database 204. The algorithms and programs can be stored in, for example, database 204 as explained above, or within processing subsystems 206 and 208.

Examples of operations performed by processing subsystems 206 and 208 include calculation of consumption data based on measurement data received from communications subsystem 202; determination, based on the received measurement data and retrieved calculation data stored in database 202, of at least one of energy available, energy expenditure per output of apparatus 100, a cost associated with the consumption of power, cost savings from consumption of power, carbon emissions reductions due to the use of renewable power sources, carbon credits due to the use of renewable power sources, and tax credits due to the use of renewable power sources; presenting the results of the calculations and determinations performed above via, for example, app 188 or other interfaces for user 178 to view on user device 164; and alerting of user 178 via transmission of alerts to app 188 running on user device 164.

Various implementations are possible for power analysis subsystem 198 and its components. Power analysis subsystem 198 can be implemented using a cloud-based approach. Power analysis subsystem 198 can be implemented across one or more facilities, where each of the components are located in different facilities and interconnection 200 is then a network-based connection. Power analysis subsystem 198 can be implemented within a single server or computer. Power analysis subsystem 198 can be implemented across multiple servers or computers. Power analysis subsystem 198 can implemented in software. Power analysis subsystem 198 can be implemented using a combination of software and hardware.

Referring now to FIGS. 6 to 9, certain features of apparatus 100 will be explained in more detail. As described above, apparatus 100 includes housing 102, which supports the components of the apparatus 100 (i.e. the charge controller, inverter, relay control subsystem, first input, second input, third input, first output, second output, and third output, as well as additional features of the apparatus 100). The charge controller 106, inverter 108, and relay control subsystem 132 are enclosed within the housing 102, and are not visible in FIGS. 6 to 9. The inputs 110, 122, 142 and outputs 112, 126, 128, 130 are provided on faces of the housing, for access by a user, as described in further detail below.

Referring to FIG. 6, the housing 102 includes a plurality of faces, three of which—i.e. face 210, 212, and 214 are shown in detail. Various arrangements of the components on the different faces of the housing 102 are possible. These arrangements include, for example: having all DC and DC-related inputs/outputs on one face of the housing, and all AC and AC-related inputs/outputs on another face of the housing; having all inputs on one face and having all outputs on another face; and having all inputs and outputs on a single face of the housing.

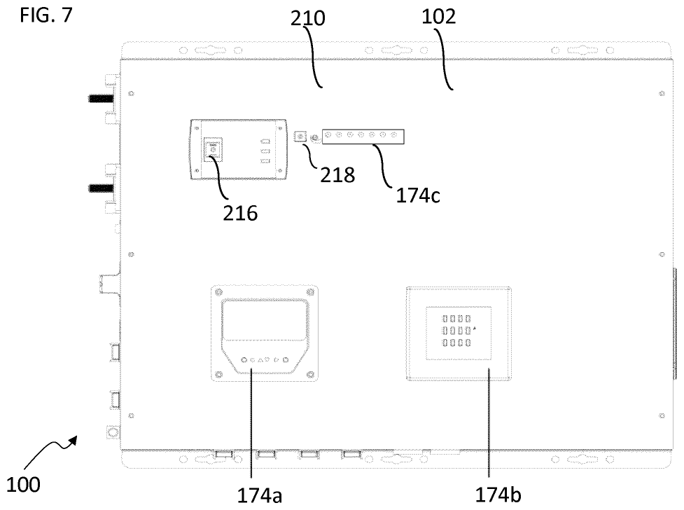

Referring to FIG. 7, in the example shown, displays 174 are provided on face 210, and include a display 174a for charge controller 106; an AC display 174b; and indicators 174c. The display 174a for charge controller 106 can be used to display measurements taken by DC meter 170 (shown in FIG. 1). Examples of displayed measurements include: the state of charge from the solar panels to the batteries; and the present state of charge of the battery voltage level. The AC display 174b can display measurements taken by AC meter 168 (shown in FIG. 1). Examples of displayed measurements include: the level of output AC voltage; load current; and total power used since the last reading was reset. The indicators 174c are in the form of an LED strip, which can inform the user when a specific event has occurred or when a specific function has been carried out. The LED strip can show the user the status of the system 104 and/or apparatus 100, and can include: charging LEDs, fault LEDs, fast charge LEDs, overload LEDs, over temperature LEDs, and power saver LEDs.

Referring still to FIG. 7, in the example shown, the apparatus includes a system switch 216, which allows the apparatus 100 to be turned on and off.

Referring still to FIG. 7, as described above, the apparatus 100 can include a power storage subsystem selector switch. In the example shown, the power storage subsystem selector switch is provided by battery selector 218. Battery selector 218 can allow the user to make the following selections: type of battery, de-sulphation mode, and turn on and turn off charging of the battery.

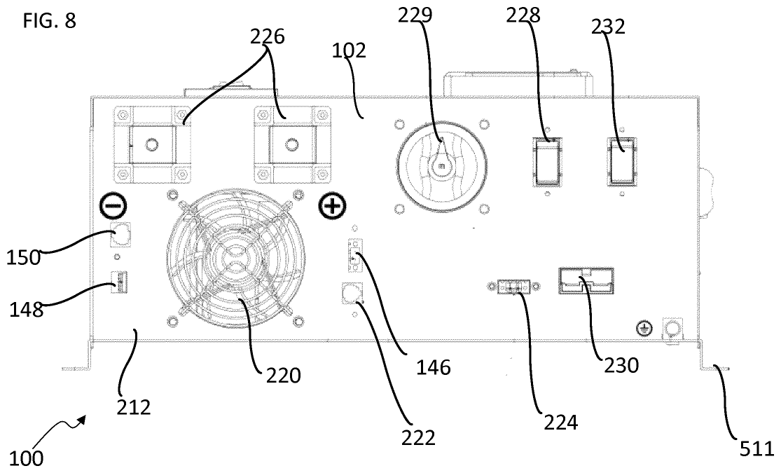

Referring now to FIG. 8, features of the temperature control subsystem 166 are shown in greater detail. A first fan, i.e. fan 220, serves to control the temperature within the housing 102. A second fan (not shown in the drawings) is also provided on the opposed face of the housing 102. As described above, the first fan 220 can be a DC fan and the second fan can be an AC fan. The temperature control subsystem 166 further includes battery temperature sensor 222, which is used to measure the temperature of the one or more batteries connected to the apparatus 100, and charge controller temperature sensor 224, which is used to measure the temperature of the one or more batteries connected to the apparatus 100.

Optionally, the apparatus 100 can further include one or more heat sinks to control the temperature within the housing 102.

Referring still to FIG. 8, in the example shown, the output 112 (described above in regards to FIG. 1 and not labeled in FIG. 8) includes DC terminal 226, which can supply the one or more batteries coupled to the apparatus 100, and battery breaker 228, which serves to protect the one or more batteries coupled to the apparatus 100. The apparatus 100 further includes a power storage subsystem switch, in the form of battery switch 229, which is provided on face 212 of the housing 102. Battery switch 229 can be used to disconnect the battery from the apparatus 100. This can allow for the battery to be easily safely disconnected from the apparatus 100, for example for servicing or for safety.

Also shown in FIG. 8 is AGS 146. As previously described, the AGS 146 can be used to send a signal to an AC generator to either turn on or off to charge up one or more batteries.

Referring still to FIG. 8, in the example shown, input 110 (described above in regards to FIG. 1 and not labeled in FIG. 8) includes solar cell input 230 as well as solar cell input breaker 232, which protects solar cell input 230.

Referring still to FIG. 8, in the example shown, inverter switches 148 include dual in-line package (DIP) switches. DIP switches can be used to select the following settings: frequency of operation of either 50 or 60 Hz, battery voltage thresholds for starting the generator, whether the apparatus 100 is an uninterrupted power supply (UPS) or an off-grid device, AC input voltage range, and power saver setting.

Referring still to FIG. 8, in the example shown, the remote switch port 150 described above is in the form of an LCD port. The LCD port can allow for the user to couple a remotely controlled switch to apparatus 100. The user can use this to remotely turn apparatus 100 on or off from a distance.

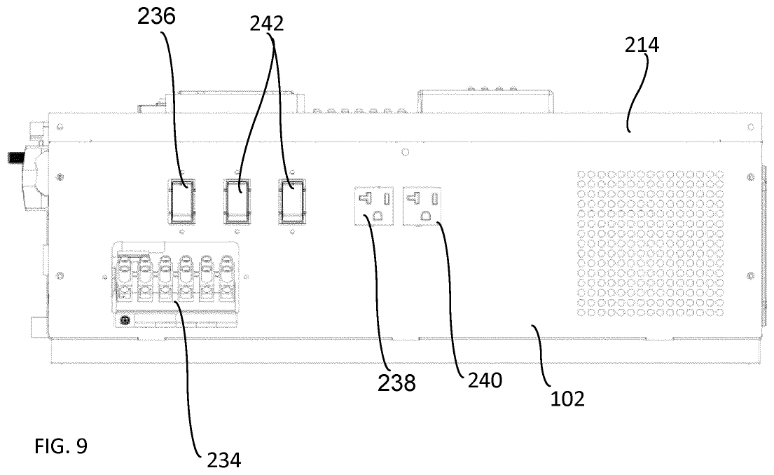

Referring now to FIG. 9, the input 142 and output 126 (described above in regards to FIG. 1 and not labeled in FIG. 9) are provided by an AC terminal strip 234, which includes an AC input and an AC output. Input 142 further includes AC input breaker 236, which serves to protect the input portion of AC terminal strip 234. The outputs 128 and 130 (described above in regards to FIG. 1 and not labeled in FIG. 9) include AC power outlets 238 and 240, as well as AC output breakers 242, which serve to protect the output portion of AC terminal strip 234, and AC power outlets 238 and 240. The AC power outlets 238 and 240 can be controlled by the relay control subsystem 132, which can be IoT-enabled, and can be remotely controlled by a user device as described previously.

Referring back to FIG. 6, in the example shown, housing 102 further includes mounting rails 244, so as to enable mounting of housing 102 on a surface such as a wall.

The apparatus 100 above can be provided and sold in various versions. For example, a 3 kilowatt (kW), 4 kW and 10 kW version can be provided or sold. The 3 kW unit can house four (4) 12 volt AGM batteries for smaller applications such as cottages. The 3 kW unit operates at 12 volts DC and has an PWM controller rated at 40 amperes (A). The 4 kW unit is for medium applications and can be mounted on a wall. The 4 kW unit operates at 24 volts DC and has an MPPT controller. The 10 kW unit is for large applications, and can be mounted on a wall. The 10 kW unit has a 60 A MPPT charge controller, can operate at 48 V DC and can accept 3 kW of input from a solar cell. The housing for the 10 kW unit is 34 inches (86.36 cm) wide, 34 inches (86.36 cm) high and has a depth of 10 inches (25.4 cm).

While the above description provides examples of one or more processes or apparatuses or compositions, it will be appreciated that other processes or apparatuses or compositions may be within the scope of the accompanying claims.

To the extent any amendments, characterizations, or other assertions previously made (in this or in any related patent applications or patents, including any parent, sibling, or child) with respect to any art, prior or otherwise, could be construed as a disclaimer of any subject matter supported by the present disclosure of this application, Applicant hereby rescinds and retracts such disclaimer. Applicant also respectfully submits that any prior art previously considered in any related patent applications or patents, including any parent, sibling, or child, may need to be re-visited.

1. An apparatus for providing power, comprising:
a charge controller coupled to an inverter;
a relay control subsystem coupled to the inverter;
a first input for coupling a first power source to the charge controller and thereby enable the charge controller to receive a first amount of power from the first power source via the first input, and adapt the received first amount of power for storage in a power storage subsystem;
a second input for coupling a second power source to the inverter and thereby enable the inverter to receive a second amount of power from the second power source via the second input, and adapt the received second amount of power for storage in the power storage subsystem;
a third input for coupling the power storage subsystem to the inverter and thereby enable the inverter to receive a third amount of power from the power storage subsystem, and convert the received third amount of power into alternating current (AC) power;
a first output for coupling the power storage subsystem to the charge controller and inverter, thereby enabling the charge controller to charge the power storage subsystem with the adapted received first amount of power, and/or the inverter to charge the power storage subsystem with the adapted second amount of power;
a second output coupled to the inverter, wherein the inverter transmits the AC power to the second output; and
a housing supporting the charge controller, inverter, relay control subsystem, first input, second input, third input, first output, and second output.

2. The apparatus of claim 1, wherein the housing encloses the charge controller, inverter, relay control subsystem, and power storage sub-system.

3. The apparatus of claim 2, wherein the housing comprises a plurality of faces, and wherein the first, second and third inputs and first and second outputs are on the at least one of the faces for access by a user.

4. The apparatus of claim 1, further comprising at least one display for displaying a status of apparatus, and/or a parameter of a component of the apparatus.

5. The apparatus of claim 4, wherein:
the first input, third input and the first output are located on a first of the plurality of faces,
the second input, and second output are located on a second of the plurality of faces, and
the display is located on a third of the plurality of faces.

6. The apparatus of claim 1, further comprising temperature control subsystem for cooling an interior of the housing.

7. The apparatus of claim 6, wherein the temperature control subsystem comprises a first and a second fan.

8. The apparatus of claim 1, further comprising an AC meter to measure one or more voltages and currents corresponding to the AC power.

9. The apparatus of claim 1, wherein the relay control sub-system is coupled to a user device and receives information from the user device.

10. The apparatus of claim 1, wherein
the AC power comprises a first amount of AC power that is transmitted to the second output, and a second amount of AC power; and
the apparatus further comprises a third output coupled to the inverter via the relay control subsystem, wherein the inverter transmits the second amount of AC power to the third output via the relay control subsystem, and the relay control subsystem controls the transmission of the second amount of AC power to the third output.

11. The apparatus of claim 10, further comprising a fourth output coupled to the inverter, wherein the inverter transmits the second amount of AC power to the fourth output, and the relay control subsystem receives one or more commands from a user device to control the transmission of the second amount of AC power to the fourth output.

12. The apparatus of claim 1, wherein the first power source is a direct current (DC) power source.

13. The apparatus of claim 1, wherein the second power source is an AC generator or a grid.

14. The apparatus of claim 1, wherein the second power source is an AC generator, the inverter detects a voltage level associated with the power storage subsystem, and when the voltage level drops below a threshold level, the inverter sends a signal to start the generator and supply power to charge up the power storage subsystem.

15. The apparatus of claim 14, wherein the inverter uses an automatic generator start (AGS) unit to send the signal to start the generator.

16. The apparatus of claim 1, further comprising a power storage subsystem switch on the housing for disconnecting the power storage subsystem from the apparatus.

17. The apparatus of claim 1, wherein the housing comprises mounting rails.

18. A method for providing power, comprising:
providing a charge controller coupled to an inverter;
providing a relay control subsystem coupled to the inverter;
providing a first input for coupling a first power source to the charge controller and enable the charge controller to receive a first amount of power from the first power source via the first input, and adapt the received first amount of power for storage in a power storage subsystem;
providing a second input for coupling a second power source to the inverter and thereby enable the inverter to receive a second amount of power from the second power source via the second input, and adapt the received second amount of power for storage in the power storage subsystem;
providing a third input for coupling the power storage subsystem to the inverter and thereby enable the inverter to receive a third amount of power from the power storage subsystem, and convert the received third amount of power into alternating current (AC) power;
providing a first output for coupling the power storage subsystem to the charge controller and inverter, thereby enabling the charge controller to charge the power storage subsystem with the adapted received first amount of power, and/or the inverter to charge the power storage subsystem with the adapted received second amount of power;
providing a second output coupled to the inverter, wherein the inverter transmits the AC power to the second output and
providing a housing supporting the charge controller, inverter, relay control subsystem, first input, second input, third input, first output, and second output.

19.-33. (canceled)

34. A system for providing power, comprising:
a first power source, and a second power source;
a power storage sub-system; and
an apparatus for providing power to a load from at least one of the first power source, second power source, and power storage sub-system, the apparatus comprising:
a charge controller coupled to an inverter;
a relay control subsystem coupled to the inverter;
a first input for coupling the first power source to the charge controller and thereby enable the charge controller to receive a first amount of power from the first power source via the first input, and adapt the received first amount of power for storage in the power storage subsystem;
a second input for coupling the second power source to the inverter and thereby enable the inverter to receive a second amount of power from the second power source via the second input, and adapt the received second amount of power for storage in the power storage subsystem;
a third input for coupling the power storage subsystem to the inverter and thereby enable the inverter to receive a third amount of power from the power storage subsystem, and convert the received third amount of power into alternating current (AC) power;
a first output for coupling the power storage subsystem to the charge controller and inverter, thereby enabling the charge controller to charge the power storage subsystem with the adapted received first amount of power, and/or the inverter to charge the power storage subsystem with the adapted second amount of power;
a second output coupled to the inverter, wherein the inverter transmits the AC power to the second output for providing power to the load; and
a housing supporting the charge controller, inverter, relay control subsystem, first input, second input, third input, first output, and second output.
